(19) United States
(12) Patent Application Publication
(10) Pub. No.: US 2011/0175434 A1
(43) Pub. Date: Jul. 21, 2011

(54) Wheel Spindle Assembly

(76) Inventors: Charles J. MacKarvich, Atlanta, GA (US); Timothy J. Prelac, Marietta, GA (US)

(21) Appl. No.: 12/687,913

(22) Filed: Jan. 15, 2010

(51) Int. Cl. B60B 35/00; F16D 55/225; B60B 35/04

(52) U.S. Cl. 301/132; 188/73.31

(57) ABSTRACT

A wheel spindle assembly including a spindle for mounting a wheel, the spindle including a proximal end and a distal end, the proximal end including a perpendicular end surface and a locator protrusion extending outwardly from the end surface. A spindle mounting plate supports the spindle and includes front and back surfaces and a centrally positioned locator opening. The locator opening is sized and shaped to receive the locator protrusion such that engagement of the locator protrusion within the locator opening and abutment of the front surface of the spindle mounting plate with the end surface of the proximal end of the spindle positions the spindle relative to the spindle mounting plate with the spindle extending perpendicularly from the front surface of the spindle mounting plate.

### BACKGROUND

1. Technical Field

The disclosure generally relates to wheel spindles.

2. Description of the Related Art

Wheel spindles are used for mounting wheels to a vehicle, such as to an automobile or trailer. A spindle acts as an axle for the wheel and the wheel may include a rubber tire mounted about a rim, a brake disc mounted to the rim, and the rim and its bearings are rotatably mounted about the spindle.

FIGS. 1 and 2 show a typical prior art wheel spindle assembly 10 that includes a spindle 12 mounted to a spindle mounting plate 14. The spindle mounting plate serves as an attachment fixture for various braking components (not shown) associated with a wheel (also not shown). Spindle mounting plate 14 includes a large central opening 16 through which the large proximal end 18 of the spindle extends.

The proximal end 18 of the spindle extends between flange 20 and a terminal annular recess 22. A far side surface 24 of spindle mounting plate 14 abuts annular surface 26 of flange 20. A weldment 28 is applied to the flange 20 and to the adjacent surface of spindle mounting plate 14 and secures the spindle 12 to the spindle mounting plate. An open end of axle tube 32 is fitted about the proximal end 18 in the terminal annular recess 22, and a weldment 34 secures the proximal end of the spindle 12 to the axle tube 22.

While the prior art spindle assemblies function to mount spindles to the axle of a vehicle, it would be desirable to provide a spindle assembly that is designed to be stronger, more durable and easier to assemble.

### SUMMARY

This disclosure concerns a new wheel spindle assembly that may be used to mount wheels to the suspension system of vehicles, such as to passenger cars and trailers. In this regard, an exemplary embodiment of the new wheel spindle assembly for a vehicle as disclosed herein may include a spindle for mounting a wheel to a spindle mounting plate, the spindle including a proximal end, a distal end, an intermediate body portion, and a longitudinal central axis extending from said proximal end to said distal end. The proximal end of the spindle has an end surface that is perpendicular to the longitudinal axis of the spindle and the proximal end of the spindle is positioned with its end surface in flat abutment with the spindle mounting plate.

The end surface at the proximal end of the spindle may include a locator protrusion extending outwardly from its end surface. The spindle mounting plate has a flat mounting surface and a locator opening that extends into or through the spindle mounting plate. The locator opening of the spindle mounting plate is sized and shaped to receive the locator protrusion of the spindle, such that engagement of the locator protrusion within the locator opening and the abutment of the proximal end surface of the spindle with the facing surface of the spindle mounting plate positions the spindle in the predetermined location on the spindle mounting plate, with the spindle extending perpendicularly from the front surface of the spindle mounting plate.

Another exemplary embodiment of a wheel spindle assembly for a vehicle includes a spindle for mounting a wheel, the spindle including a proximal end, a distal end, an intermediate body portion, and a longitudinal central axis extending from the proximal end to the distal end. The proximal end of the spindle includes an end surface that is perpendicular to the longitudinal axis for mounting in flat abutment with a spindle mounting plate, such that engagement of the back surface of the proximal end of the spindle in flat abutment with the facing surface of the spindle mounting plate positions the spindle relative to the spindle mounting plate with the spindle extending perpendicularly from the facing surface of the spindle mounting plate. A weldment may be formed at the intersection of the spindle body with the spindle mounting plate to rigidly attach the spindle to its mounting plate, with the back surface of the spindle being supported by the facing surface of the spindle backing plate.

Another example of the spindle assembly is a locater protrusion may be positioned on the end surface of the proximal end of the spindle and extending from the end surface, and a spindle mounting plate may include a locator opening, the locator opening being sized and shaped to receive the locator protrusion of the spindle for mounting the spindle in a predetermined position on the mounting plate.

A caliper mounting plate may be mounted to and be substantially parallel to the spindle mounting plate, a brake disc rotatably mounted on the spindle and rotatable with respect to the spindle mounting plate, and a caliper mounted on the caliper mounting plate and having brake pads juxtaposed opposite sides of the brake disc for releasably engaging the brake disc.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is an exploded perspective view of a spindle and spindle mounting plate of a prior art wheel spindle assembly.

FIG. 2 is a cross-sectional view of the prior art wheel spindle assembly of FIG. 1, showing an intermediate portion of the spindle mounted to the mounting plate and mounted at its end to an axle tube.

FIG. 3 is an exploded perspective view of a spindle and spindle mounting plate of an exemplary embodiment of a wheel spindle assembly.

FIG. 4 is another exploded perspective view of the wheel spindle assembly of FIG. 3.

FIG. 5 is a perspective view of the wheel spindle assembly of FIGS. 3 and 4 in an assembled configuration.

FIG. 6 is a cross-sectional view of the wheel spindle assembly of FIGS. 3-5 mounted to an axle tube.

FIG. 7 is an exploded perspective view, similar to FIG. 4, but illustrating a modified form of the spindle and its spindle mounting plate.

FIG. 8 is a cut-away view of another embodiment of the wheel spindle assembly.

### DETAILED DESCRIPTION

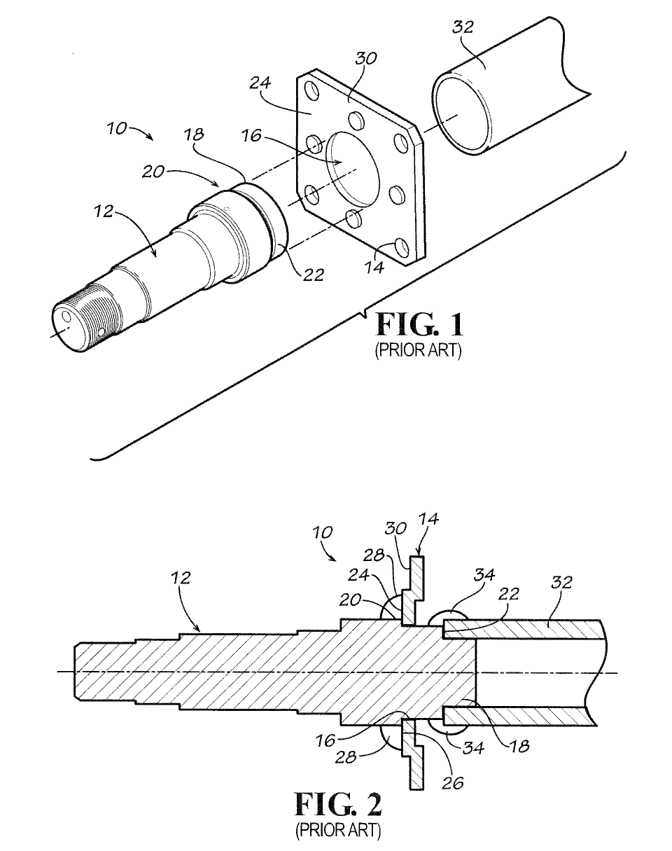

Wheel spindle assemblies are provided, several exemplary embodiments of which will be described in detail. In some embodiments, a spindle mounting plate of the assembly includes a relatively small central opening and a spindle includes a corresponding locator button that is sized and shaped to register with the opening. So registered, an adjacent bearing surface at the larger end of the spindle abuts and bears against the facing surface of the spindle mounting plate. A first weld rigidly connects the spindle to the spindle mounting plate, and an axle tube is rigidly connected to the back side of the spindle mounting plate by a second weld. This is in contrast to connecting the axle tube to the spindle such as shown in the prior art configuration of FIGS. 1 and 2.

The aforementioned configuration may tend to be stronger than the prior art configuration in that the spindle mounting plate retains more material and does not rely upon a precisely accurate fit of the proximal end of the spindle inside the spindle mounting plate. In one embodiment a locator button is used for properly aligning the spindle and the plate. Moreover, there tends to be more bearing surface between the larger proximal end of the spindle and the spindle mounting plate.

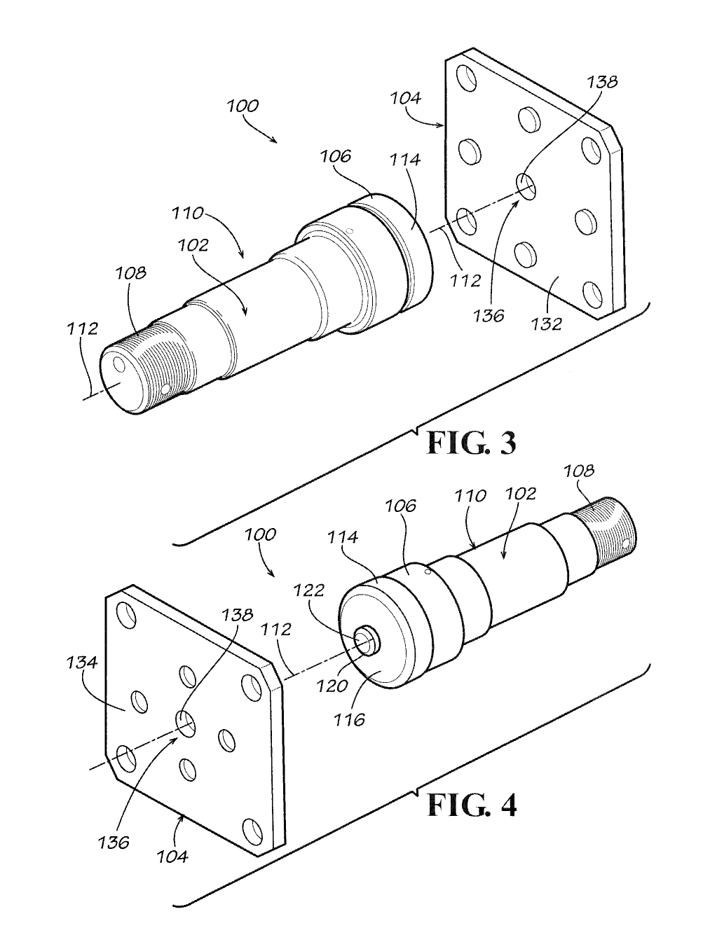

In this regard, reference is made to FIGS. 3 and 4, which depict an exemplary embodiment of a wheel spindle assembly for a vehicle. Wheel spindle assembly 100 incorporates a spindle 102 for mounting a wheel (not shown) and a spindle mounting plate 104. Spindle 102 includes a proximal end 106, a distal end 108, an intermediate body portion 110 located between the ends 106, 108, and a longitudinal central axis 112 that extends between the ends (106, 108).

In the embodiment of FIGS. 3 and 4, the proximal end 106 includes a substantially cylindrical surface 114 and a substantially flat end surface 116. A locator protrusion 120 is positioned along axis 112 and extends outwardly from end surface 116, although off-axis positions of the locator protrusion can be used in other embodiments. Locator protrusion 120 is a generally cylindrical protrusion with a substantially flat end 122, although various other shapes can be used.

Spindle mounting plate 104 includes a front surface 132 and an opposing back surface 134 that are generally parallel in this embodiment, although other configurations can be used. A locator opening 136, which is configured as a through hole in this embodiment, is sized and shaped to receive locator protrusion 120. Opening 136 and protrusion 120 are complementary in shape and are sized so that the cylindrical surface of the protrusion snugly engages the cylindrical wall 138 that defines opening 136.

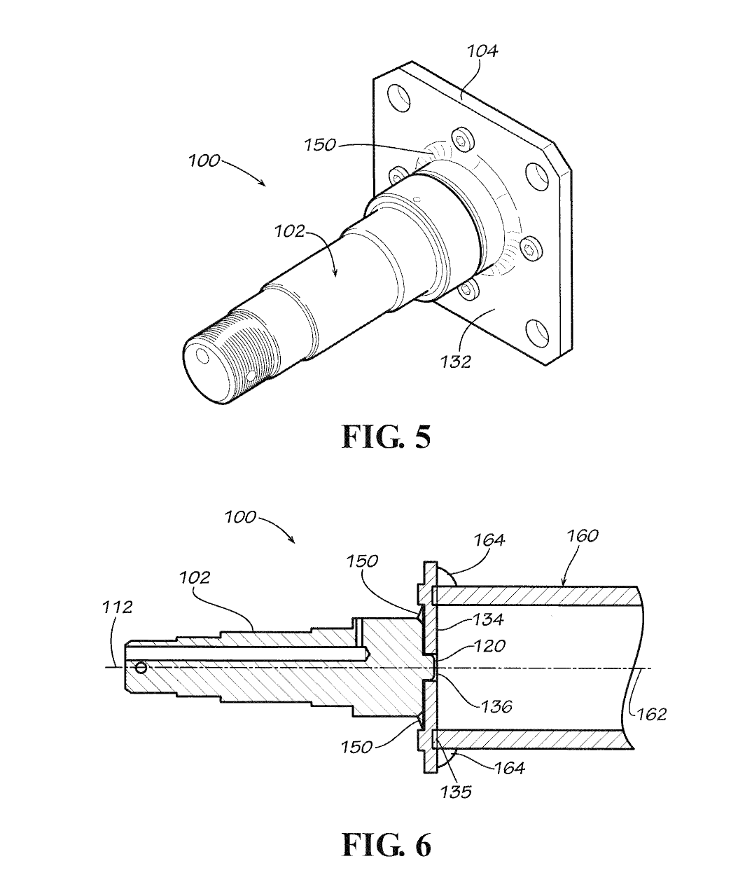

Engagement of the locator protrusion 120 within the locator opening 136, in cooperation with flat abutment of the front surface 132 of the spindle mounting plate with the facing end surface 116 of the spindle, positions the spindle 102 relative to the spindle mounting plate 104 so that the spindle extends outwardly and perpendicularly from the front surface of the spindle mounting plate, as shown in FIG. 5.

It should be noted that, in other embodiments, the locator opening may be configured as a recess in contrast to a through hole and may be non-circular. Additionally or alternatively, in some embodiments, the sizes and/or shapes of the locator protrusion and opening can depart from those shown in FIGS. 3 and 4. In such an embodiment, various types of engagement other than snug engagement between the protrusion and opening may be achieved. Similarly, the shapes of the front surface of the spindle mounting plate and the end surface of the spindle may be such that various types of engagement other than flat engagement are achieved in some embodiments.

FIG. 5 is a perspective view of the wheel spindle assembly 100 of FIGS. 3 and 4 in an assembled configuration. As shown in FIG. 5, spindle 102 is connected to spindle mounting plate 104 by a spindle weld 150 that is located between the cylindrical surface 114 of the spindle and the front surface 132 of the spindle mounting plate.

FIG. 6 is a cross-sectional view of the wheel spindle assembly 100 of FIGS. 3-5 mounted to an axle tube 160. Axle tube 160 exhibits a longitudinal axis 162 that is coaxially aligned with longitudinal axis 112 of spindle 102. The axle tube is mounted to the back surface 134 of the spindle mounting plate by a weld 164. A groove 135 may be formed in the back of the spindle mounting plate to receive the circular end portion of the axle tube 1160. As such, forces applied by the spindle to the spindle mounting plate are transmitted through the spindle mounting plate to axle tube 160.

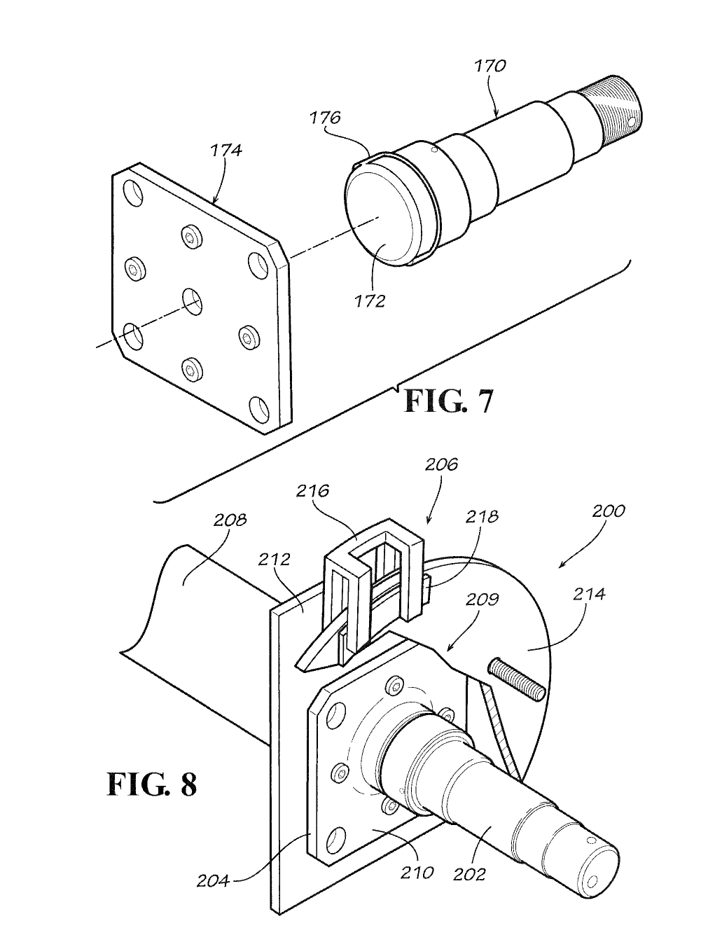

FIG. 7 illustrates a spindle 170 having a flat proximal end surface 172 without a locator protrusion and a spindle mounting plate 174 without a locator opening, with the flat surface 172 of the proximal end of the spindle to be placed in flat abutment with the flat facing surface of the spindle mounting plate. This configuration allows the spindle support plate to retain its continuous flat surface without an opening in this area of the spindle mounting plate, thereby avoiding the removal of material of the spindle mounting plate and preserving the strength of the spindle mounting plate. A weldment (not shown in FIG. 7) similar to the weldment 150 of FIGS. 5 and 6 is formed at the intersection of the perimeter of the proximal end 176 of the spindle 170 and the facing surface of the spindle mounting plate 174 permanently mounts the spindle to the spindle mounting plate.

FIG. 8 is a cut-away view of another embodiment of a wheel spindle assembly. As shown in FIG. 7, wheel spindle assembly 200 incorporates a spindle 202, a spindle mounting plate 204, a brake assembly 206 and an axle tube 208. Spindle 202 includes a proximal end 209 that is mounted to a front surface 210 of the spindle mounting plate, with the back surface of the spindle mounting plate being attached to the axle tube.

Brake assembly 206 includes a caliper mounting plate 212, a brake disc 214, a caliper 216 and brake pads (e.g., pad 218). Caliper mounting plate 212 is supported by spindle mounting plate 204 (e.g., welded, bolted), with the brake disc 214 being rotatably mounted on spindle 202 so that the brake disc rotates with respect to spindle mounting plate 204. Caliper 216 is supported by the caliper mounting plate and mounts the brake pads (only pad 218 is shown), which are juxtaposed opposite sides of the brake disc. In operation, the caliper urges the brake pads toward each other to releasably engage the brake disc.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. By way of example, although a disc brake assembly is shown in the embodiment of FIG. 7, other configurations of brakes (e.g., drum brakes) can be used. All such modifications and variations are intended to be included herein within the scope of this disclosure and protected by the accompanying claims.

1. A wheel spindle assembly for a vehicle comprising:
a spindle for mounting a wheel, the spindle including a proximal end, a distal end, an intermediate body portion, and a longitudinal central axis extending from the proximal end to the distal end,
the proximal end having an end surface perpendicular to the longitudinal axis and a locator protrusion positioned centrally of the end surface and coincident the longitudinal axis and extending from the end surface,
a spindle mounting plate having opposed front and back parallel surfaces, and a centrally positioned locator opening, the locator opening being sized and shaped to receive the locator protrusion such that engagement of the locator protrusion within the locator opening and abutment of the front surface of the spindle mounting plate with the end surface of the proximal end of the spindle positions the spindle relative to the spindle mounting plate with the spindle extending perpendicularly from the front surface of the spindle mounting plate,
a caliper mounting plate mounted to and substantially parallel to the spindle mounting plate,
a brake disc rotatably mounted on the spindle and rotatable with respect to the spindle mounting plate, and
a caliper mounted on said caliper mounting plate and having brake pads juxtaposed opposite sides of said brake disc for releasably engaging said brake disc.

2. The wheel spindle assembly of claim 1, wherein:
said proximal end of said spindle has a substantially cylindrical surface; and
said end surface is substantially flat and is in flat engagement with said spindle mounting plate.

3. The wheel spindle assembly of claim 1, wherein said caliper mounting plate straddles said spindle and is mounted to said front surface of said spindle mounting plate.

4. The wheel spindle assembly of claim 1, wherein said spindle mounting plate supports said caliper.

5. The wheel spindle assembly of claim 1, wherein said locator opening of said spindle mounting plate is a through hole and does not limit the passing of a portion of said locator protrusion through said locator opening.

6. The wheel spindle assembly of claim 2, wherein said spindle is connected to said spindle mounting plate by a spindle weld between said cylindrical surface of said spindle and said front surface of said spindle mounting plate.

7. The wheel spindle assembly of claim 6, further comprising an elongated axle tube with a longitudinal axis coaxially aligned with said longitudinal axis of said spindle and mounted to said back surface of said spindle mounting plate, such that forces applied by said spindle to said spindle mounting plate are transmitted through said spindle mounting plate to said axle tube.

8. A wheel spindle assembly for a vehicle comprising:
a spindle for mounting a wheel, said spindle including a proximal end, a distal end, an intermediate body portion, and a longitudinal central axis extending from said proximal end to said distal end, said proximal end having an end surface and a locator protrusion extending outwardly from said end surface; and
a spindle mounting plate having front and back surfaces, and a locator opening, said locator opening being sized and shaped to receive said locator protrusion such that engagement of said locator protrusion within said locator opening and abutment of said front surface of said spindle mounting plate with said end surface of said proximal end of said spindle positions said spindle relative to said spindle mounting plate with said spindle extending from said front surface of said spindle mounting plate.

9. The wheel spindle assembly of claim 8, wherein said protrusion is coincident said longitudinal axis.

10. The wheel spindle assembly of claim 8, wherein said front and back surfaces of said spindle mounting plate are parallel surfaces.

11. The wheel spindle assembly of claim 8, wherein said locator opening is located at a central position of said spindle mounting plate.

12. The wheel spindle assembly of claim 8, further comprising an elongated axle tube with a longitudinal axis coaxially aligned with said longitudinal axis of said spindle and mounted to said back surface of said spindle mounting plate such that forces applied by said spindle to said spindle mounting plate are transmitted through said spindle mounting plate to said axle tube.

13. The wheel spindle assembly of claim 8, further comprising:
a caliper mounting plate mounted to said spindle mounting plate;
a brake disc rotatably mounted on said spindle and rotatable with respect to said spindle mounting plate, and
a caliper mounted on said caliper mounting plate and having brake pads juxtaposed opposite sides of said brake disc for releasably engaging said brake disc.

14. The wheel spindle assembly of claim 8, further comprising a brake assembly mounted to said spindle mounting plate.

15. The wheel spindle assembly of claim 8, wherein said locator opening of said spindle mounting plate is a through hole.

16. The wheel spindle assembly of claim 8, wherein:
said proximal end of said spindle has a substantially cylindrical surface; and
said end surface is substantially flat and is in flat engagement with said spindle mounting plate.

17. The wheel spindle assembly of claim 16, wherein said spindle is connected to said spindle mounting plate by a spindle weld between said cylindrical surface of said spindle and said front surface of said spindle mounting plate.

18. The wheel spindle assembly of claim 8, wherein said end surface of said proximal end is perpendicular to said longitudinal axis.

19. The wheel spindle assembly of claim 8, wherein engagement of said locator protrusion within said locator opening and abutment of said front surface of said spindle mounting plate with said end surface of said proximal end of said spindle positions said spindle relative to said spindle mounting plate with said spindle extending perpendicularly from said front surface of said spindle mounting plate.

20. A wheel spindle assembly for a vehicle comprising:
a spindle for mounting a wheel,
said spindle including a proximal end, a distal end, an intermediate body portion, and a longitudinal central axis extending from said proximal end to said distal end, said proximal end having an end surface perpendicular to said longitudinal axis,
a spindle mounting plate having a front surface,
said end surface of said proximal end of said spindle mounted in flat abutment with said front surface of said spindle mounting plate, and
a weldment formed at the intersection of said proximal end of said spindle and said front surface of said spindle mounting plate.

21. The wheel spindle assembly of claim 20 and further including
a caliper mounting plate mounted to and substantially parallel to said spindle mounting plate,
a brake disc rotatably mounted on said spindle and rotatable with respect to said spindle mounting plate, and
a caliper mounted on said caliper mounting plate and having brake pads juxtaposed opposite sides of said brake disc for releasably engaging said brake disc.

22. The wheel spindle assembly of claim 20 and further including
a locator protrusion positioned on said end surface of said spindle and extending from said end surface of said spindle,
a locator opening formed in said spindle mounting plate, said locator opening being sized and shaped to receive said locator protrusion of said spindle such that said end surface of said proximal end of said spindle is mounted in flat abutment with said front surface of said spindle mounting plate and said locator protrusion registers within said locator opening with said spindle extending perpendicularly from said front surface of said spindle mounting plate.

23. A spindle for mounting a wheel,
said spindle including a proximal end, a distal end, an intermediate body portion, and a longitudinal central axis extending from said proximal end to said distal end,
said proximal end of said spindle including a flat end surface perpendicular to said longitudinal axis and a locator protrusion extending outwardly from said flat end surface.

24. The spindle of claim 23, and further including
a spindle mounting plate including a flat mounting surface defining a locator opening sized and shaped to receive said locator protrusion of said spindle,
and a weldment holding said spindle to said spindle mounting plate.
